(19) United States
(12) Patent Application Publication
(10) Pub. No.: US 2023/0136502 A1
(43) Pub. Date: May 4, 2023

(54) HIGH DENSITY VIRTUAL CONTENT CREATION SYSTEM AND METHOD

(71) Applicant: FOUNDATION FOR RESEARCH AND BUSINESS, SEOUL NATIONALUNIVERSITY OF SCIENCE AND TECHNOLOGY, Seoul (KR)

(72) Inventors: Dong Ho KIM, Seoul (KR); So Hee KIM, Seoul (KR); Yu Jin YANG, Seoul (KR)

(21) Appl. No.: 17/567,912

(22) Filed: Jan. 4, 2022

(30) Foreign Application Priority Data
Oct. 29, 2021 (KR) 10-2021-0146902
Dec. 31, 2021 (KR) 10-2021-0194516

(51) Int. Cl. G06V 10/46; G06T 5/40; G06V 10/20; G06V 10/98; G06T 5/10

(52) U.S. Cl. CPC G06V 10/462; G06T 5/40; G06V 10/255; G06V 10/98; G06T 5/10; G06T 2207/10028

(57) ABSTRACT

A system and method for creation of high density virtual content is provided, according to a preferred embodiment, a point is selected within a point cloud extracted from the original image; a radius set using a ratio of the distance between the selected point and the closest point thereto to the resolution of the original image is sequentially reset at predetermined intervals to create virtual content for each reset radius; and a section-wise optimal radius is derived from all the radii on the basis of the color image differences between each created virtual content and the original image for each section, thereby creating virtual content with the derived optimal radius for each section, whereby it is possible to implement a sense of reality for high density virtual content with a small number of samples.

### BACKGROUND OF THE INVENTION

### Field of the Invention

The present invention relates to a system and method for creation of high density virtual content and, more particularly, to a system and method for creation of high density virtual content which is configured to evaluate the performance of virtual content and create high density virtual content according to the evaluation result.

### Description of the Related Art

With the recent entry into a non-face-to-face society, the consumption of virtual reality (VR) content and augmented reality (AR) content is increasing. In order to create such VR/AR content, more data amount than existing audio, voice, and video are required.

To reduce amounts of such data, VR/AR content is created by randomly selecting points corresponding to only a predetermined distance, decreasing the number of samples so that samples close to the selected point are not too close, and then filling random samples.

Conventionally, the performance of VR/AR content was evaluated through visual naked-eye identification between the created VR/AR content and the original content, and high density VR/AR content was created by reducing the number of samples on the basis of the evaluation result. However, because the performance evaluation of VR/AR content based on the naked eye identification is subjective, the accuracy of the result of the performance evaluation is lowered, and high density VR/AR content is not capable of being created accordingly. Therefore, there is a limit that the sense of reality for the created VR/AR content is reduced.

In this regard, the present applicant propose a solution of quantitatively performing evaluation for the performance of VR/AR content and creating high density virtual content on the basis of a result of the quantitative evaluation for the performance of VR/AR content.

### DOCUMENTS OF RELATED ART

(Patent Document 1) Korean Patent application registration No. 10-1850410 (Simulation device and method for virtual reality-based robot)

### SUMMARY OF THE INVENTION

Accordingly, the present invention has been made keeping in mind the above problems occurring in the related art, and an objective of the present invention is to provide a system and method for creation of high density virtual content, which is configured to remove samples within a circle having a predetermined radius and centered on one point of a point cloud extracted at a predetermined angle to create virtual content and quantitatively evaluate the performance of the created virtual content, thereby creating high density virtual content on the basis of a result of the quantitative evaluation for the performance of the virtual content.

Another objective of the present invention is to improve a sense of reality for high density virtual content and further enhance interest in the virtual content.

The objectives of the present invention are not limited to those mentioned above, but other objectives and advantages of the present invention not mentioned may be understood by the following description and will be more clearly understood by the embodiments of the present invention. It will also be readily apparent that the objectives and advantages of the present invention can be realized by the means and combinations thereof indicated in the appended claims.

According to an embodiment of the present invention, a system for creation of high density virtual content is provided, the system including: a virtual content creation unit extracting a point cloud at a predetermined angle by scanning an object that is to be created as virtual content, removing samples in a circle having a set radius and centered on one point in the extracted point cloud to create virtual content, and sequentially resetting the set radius at predetermined intervals to create virtual content with each of the reset radii; a virtual content performance evaluation unit deriving a color image difference between the virtual content and an original image for each section and deriving an optimal radius for each section, from the radii reset with the derived color image difference for each section; and a high density virtual content creation unit creating high density virtual content with the optimal radius set for each section.

Preferably, the virtual content creation unit includes: a radius setting module selecting one point in the point cloud extracted from the original image and setting the radius using a ratio of a distance between the selected point and the closest point thereto to a resolution of the original image; a virtual content creation module extracting the point cloud at a predetermined angle by scanning the object to be crated as virtual content in a virtual space, removing the sample within the circle having the set radius and centered on one point in the extracted point cloud to create the virtual content; and a radius resetting module sequentially resetting the set radius at predetermined intervals, and the virtual content creation module may be configured to create virtual content with each of radii sequentially reset.

Preferably, the virtual content performance evaluation unit may include: a section division module dividing the virtual content created with each of the radii sequentially reset into a plurality of sections; a color image difference derivation module comparing the original image with virtual content for each divided section to derive the color image difference for each section and thus generate a union of the color image difference for each section; and an optimal radius setting module deriving the optimal radius for each section, from the reset radii on the basis of the derived color image difference for each section.

Preferably, the union of the color image difference for each section may be derived as the union of the difference between the original image Drgb(r=a, s=y) and the virtual content Drgb(r=a, s=y), in which the color image difference Drgb (r=a, s=y) for each section is provided to satisfy Equation 1 below:

$${{⋃}_{y = 1}}^{S} {D}_{rgb} ( r = a , s = y ) = {{⋃}_{y = 1}}^{S} [ \vert {I}_{rgb} ( r = a , s = y ) - {M}_{rgb} ( r = a , s = y ) \vert ] \qquad [ Equation 1 ]$$

wherein, r is a radius of Poisson disk sampling, s is a section number, and a and b are constants.

Preferably, the virtual content performance evaluation unit may further include a histogram derivation module that derives a histogram for the derived color image difference for each section, to quantitatively derive the performance for the virtual content with each reset radius using the histogram for the color image difference for each section.

Preferably, the color image difference derivation module may perform first correction on an angular error between the original image and the virtual content by using a scale invariant feature transform (SIFT) algorithm that matches each feature point of the original image with the virtual content, and then perform secondary correction on an angular error generated in the scale invariant feature transform (SIFT) calculation process, to compare the original image with virtual content for each section.

Preferably, the optimal radius may be set as a radius with a smaller color image difference, from color image differences for each of the reset radii.

According to another embodiment of the present invention, a method for creation of high density virtual content is provided, the method including: a virtual content creation step of extracting a point cloud at a predetermined angle by scanning an object that is to be created as virtual content, removing samples within a circle having a set radius and centered on one point in the extracted point cloud to create virtual content, and sequentially resetting the set radius at predetermined intervals to create virtual content with each of the reset radii; a virtual content performance evaluation step of dividing the created virtual content into sections, generating a color image difference between virtual content for each of divided sections and an original image, and setting an optimal radius for each section with the generated color image difference for each section; and a high density virtual content creation step of creating high density virtual content with the optimal radius set for each section.

Preferably, the virtual content creation step may include: a radius setting step of selecting one point in the point cloud extracted from the original image and setting the radius using a ratio of a distance between the selected point and the closest point thereto to a resolution of the original image; a virtual content creating step of extracting the point cloud at a predetermined angle by scanning the object to be crated as virtual content in a virtual space, removing the samples within the circle having the set radius and centered on one point in the extracted point cloud to create the virtual content; and a radius resetting step of sequentially resetting the set radius at predetermined intervals, and the virtual content creating step may be performed after removing the samples within the circle having each of the reset radii.

Preferably, the virtual content performance evaluation step may include: a section division step of dividing the virtual content created with each of the radii into a plurality of sections; a color image difference derivation step of comparing the original image with virtual content for each divided section to derive the color image difference for each section and thus generate a union of the color image difference for each section; and an optimal radius setting step of deriving the optimal radius for each section, from the reset radii on the basis of the derived color image difference for each section.

Preferably, the color image difference derivation step may include performing first correction on an angular error between the original image and the virtual content by using a scale invariant feature transform (SIFT) algorithm that matches each feature point of the original image with the virtual content, and then performing secondary correction on an angular error generated in the scale invariant feature transform (SIFT) calculation process, to compare the original image with the virtual content for each divided section.

Preferably, the color image difference deriving step may further include a histogram derivation step of deriving a histogram for the derived color image difference for each section, to quantitatively derive the performance for the virtual content having each reset radius using the histogram for the color image difference for each section.

According to an embodiment, it is possible to implement a sense of reality for high density virtual content with a small number of samples, and accordingly it is possible to create high density virtual content using a lightweight device, since a point is selected within a point cloud extracted from the original image; a radius set using a ratio of the distance between the selected point and the closest point thereto to the resolution of the original image is sequentially reset at predetermined interval to create virtual content for each reset radius; and a section-wise optimal radius is derived from all the radii on the basis of the color image differences between each created virtual content and the original image for each section, thereby creating virtual content with the derived optimal radius for each section.

In addition, according to an embodiment, it is possible to quantitatively derive the performance for virtual content created with each radius reset by a histogram of the color image difference for each reset radius, and accordingly it is possible to improve the reliability for the high density virtual content.

### BRIEF DESCRIPTION OF THE DRAWINGS

The accompanying drawings with respect to the specification illustrate preferred embodiments of the present invention and serve to further convey the technical idea of the present invention together with the description of the present invention given below, and accordingly the present invention should not be construed as limited only to descriptions in the drawings, in which:

FIG. 1 is a block diagram showing a high density virtual content creation system according to an embodiment;

FIG. 2 is a detailed configuration diagram of the virtual content creation unit of FIG. 1;

FIG. 3 is a diagram showing a processing process of the virtual content creation unit of FIG. 2;

FIG. 4 is a detailed configuration diagram of the virtual content performance evaluation unit of FIG. 1;

FIG. 5 is a diagram showing a processing process of the virtual content performance evaluation unit of FIG. 4;

FIG. 6 is an exemplary view showing each section of the section division module of FIG. 4;

FIG. 7 is a view showing a histogram of the histogram derivation module of FIG. 4; and

FIG. 8 is an exemplary view showing a color image difference according to an embodiment.

### DETAILED DESCRIPTION OF THE INVENTION

Hereinafter, embodiments of the present invention will be described in more detail with reference to the drawings.

Advantages and features of the present invention, and methods of achieving them will become apparent with reference to embodiments described below together with the accompanying drawings. However, the present invention is not limited to the embodiments disclosed below, but may be implemented in various different forms. The embodiments are provided to complete the disclosure of the present invention, and to completely inform the scope of the invention to those of ordinary skill in the art to which the present invention belongs. The invention is only defined by the scope of the claims.

The terms used herein will be briefly described, and the present invention will be described in detail.

Terms used in the present invention have selected general terms that are currently widely used as possible while considering functions in the present invention, but this may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present invention should be defined based on the meaning of the term and the overall contents of the present invention, not a simple name of the term.

When a part is said to “include” one component throughout the specification, it means that other components may be further included rather than excluding other components unless otherwise specified.

Accordingly, the functionality provided within components and “units” may be combined into a smaller number of components and “parts”, or may be divided into additional components and “parts”.

Hereinafter, with reference to the accompanying drawings, embodiments of the present invention will be described in detail so that those of ordinary skill in the art can easily carry out the present invention. In order to clearly illustrate the present invention in the drawings, parts irrelevant to the description will be omitted.

Any number of components to which an embodiment is applied may be included in any suitable configuration. In general, computing and communication systems come in a wide variety of configurations, and the drawings do not limit the scope of the present disclosure to any particular configuration. Although the drawings illustrate one operating environment in which the various features disclosed in this patent document may be used, such features may be used in any other suitable system.

According to an example, a content creation server is configured to remove samples within a circle having the set radius and centered on one point of the point cloud using the Poisson disk sampling technique to create virtual content, reset the set radius at predetermined intervals to create virtual content with each reset radius, and derive an optimal radius for each section, from the reset radii on the basis of a color image difference between each virtual content and the original image for each section, thereby creating high density virtual content with the optimal radius derived for each section.

According to another embodiment, the user terminal receives the virtual content with each reset radius and each reset radius from the content creation server and the color image differences for each section in the form of data stream, and derives the optimal radius for each section on the basis of the color image difference for each section, thereby creating high density virtual content with an optimal radius for each section.

Also, according to an embodiment, the performance of virtual content created with each reset radius is quantitatively evaluated by the histogram to the color image difference for each radius reset.

Prior to the description of this specification, some terms used in this specification will be made clear. In this specification, virtual content may refer to AR/VR content in a virtual space, so that the virtual content and the AR/VR content may be interchangeably used.

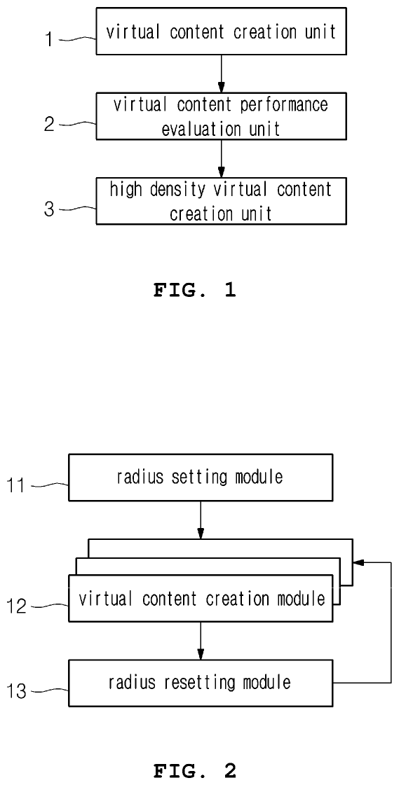

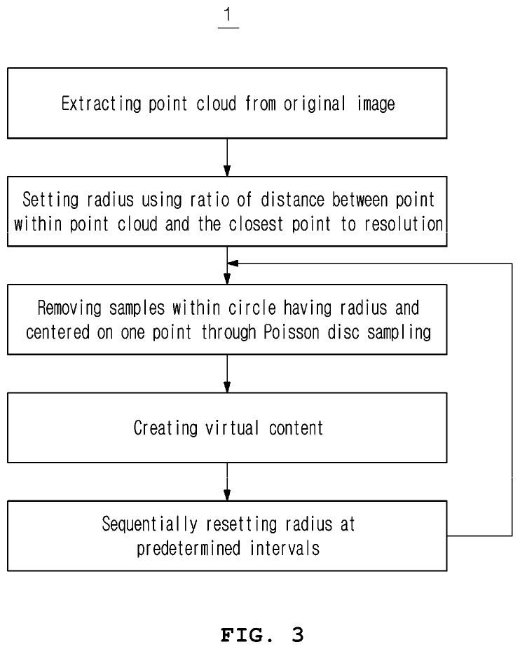

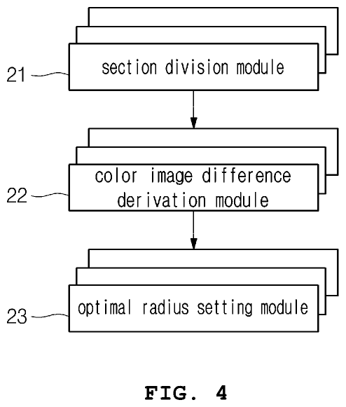

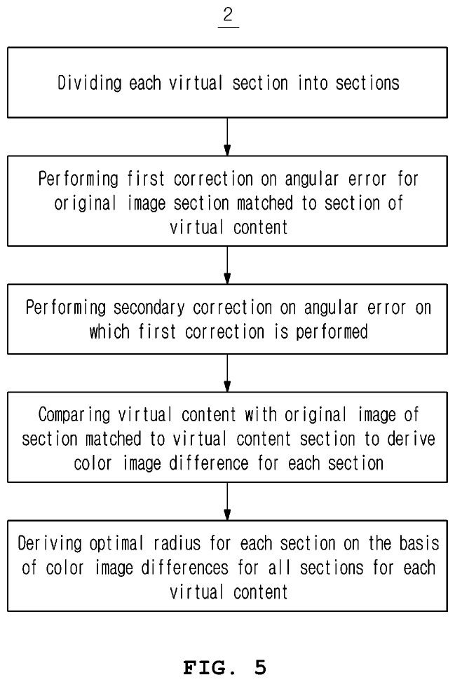

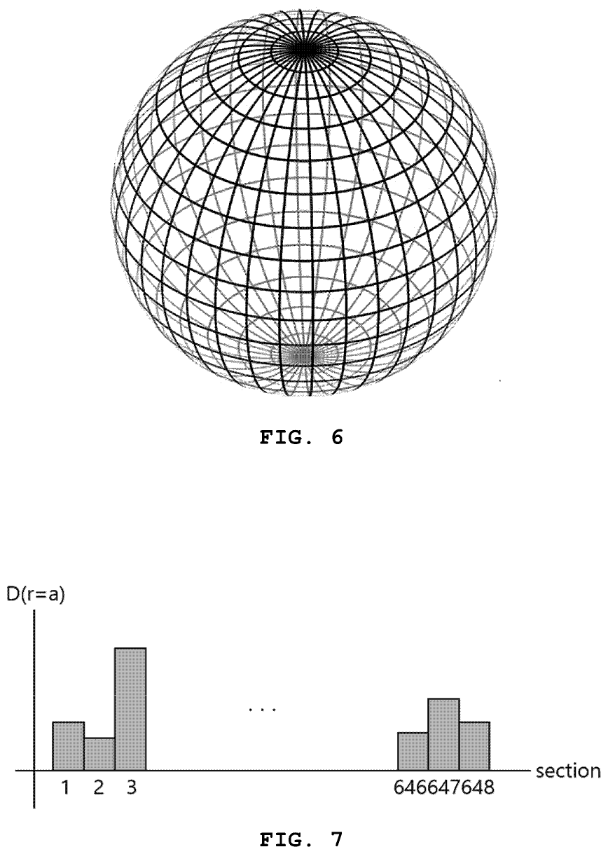

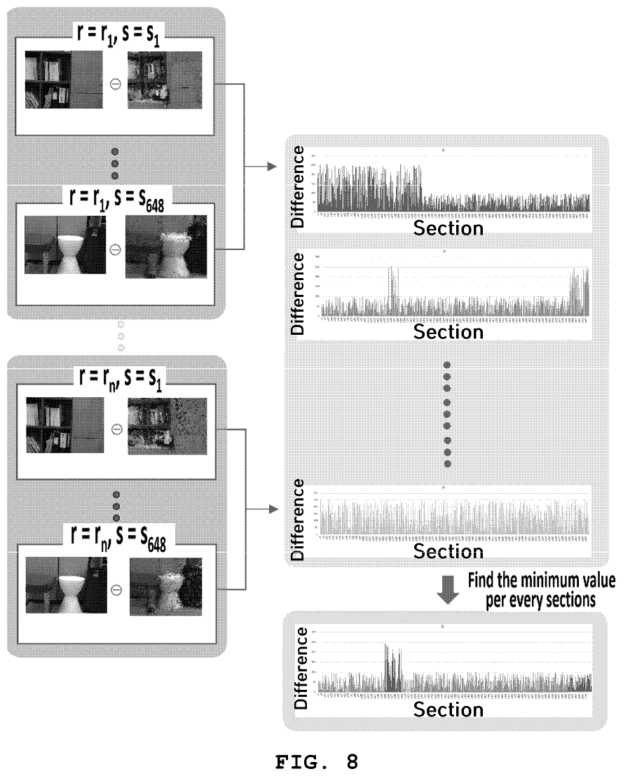

FIG. 1 is a block diagram showing a high density virtual content creation system according to an embodiment; FIG. 2 is a detailed configuration diagram of the virtual content creation unit of FIG. 1; FIG. 3 is a diagram illustrating a processing process of the virtual content creation unit of FIG. 2; FIG. 4 is a detailed configuration diagram of the virtual content performance evaluation unit of FIG. 1; FIG. 5 is a diagram illustrating a processing process of the virtual content performance evaluation unit of FIG. 4; FIG. 6 is an exemplary view showing each section of the section division module of FIG. 4; FIG. 7 is a view showing a histogram of the histogram derivation module of FIG. 4; and FIG. 8 is an exemplary view showing a color image difference according to an embodiment.

Referring to FIGS. 1 to 8, the high density virtual content creation system according to an embodiment is configured with a virtual content creation unit 1, a virtual content performance evaluation unit 2, and a high density virtual content creation unit 3. The high density virtual content creation system is configured to remove samples within a circle having a set radius and centered on one point in the point cloud to create virtual content, reset the set radius at predetermined intervals to create virtual content for each reset radius, derive an optimal radius for each section, from the reset radii on the basis of the color image difference between the virtual content and the original image for each section, thereby creating high density virtual content with the optimal radius derived for each section.

Here, the virtual content creation unit 1 is configured to extract the point cloud at a predetermined angle by scanning an object that is to be created as virtual content, set a radius of a circle centered on one point in the extracted point cloud, remove points within the circle having the set radius to create and save the virtual content, and sequentially reset the set radius at predetermined intervals, thereby creating the virtual content with each reset radius.

That is, the virtual content creation unit 1, as shown in FIG. 2, may include a radius setting module 11, a virtual content creation module 12, and a radius resetting module 13. An operation process of the virtual content creation unit 1 will be described in detail with reference to FIG. 3.

That is, the radius setting module 11 randomly selects one point in the point cloud extracted from the original image and sets the radius using a ratio of the distance between the selected point and the closest point to the resolution of the original image. The set radius is transmitted to the virtual content creation module 12.

The virtual content creation module 12 extracts a point cloud at a predetermined angle by scanning an object that is to be created with content virtual in a virtual space, removes samples within a circle having a set radius and centered on a single point in the extracted point cloud as the center, and then creates virtual content. For example, the sample within the circle may be removed using a Poisson disk sample technique, and the virtual content may be a mesh model generated using a mesh platform.

In addition, the radius resetting module 13 resets the set radius at predetermined size intervals, and delivers each reset radius to the virtual content creation module 12. Here, the predetermined size intervals may be set differently on the basis of the resolution of content to be created. Accordingly, the virtual content creation module 12 removes the sample included in the circle of the reset radius using the Poisson disk sample technique, and then creates virtual content. Accordingly, the virtual content may be created on the basis of each reset radius, and then transmitted to the virtual content performance evaluation unit 2.

The virtual content performance evaluation unit 2 may include a section division module 21, a color image difference derivation module 22, and an optimal radius derivation module 23, as shown in FIG. 4. An operation process of the virtual content performance evaluation unit 2 will be described in more detail with reference to FIG. 5.

The section division module 21 divides the virtual content into predetermined sections at a predetermined angle and length, and delivers the virtual content for each divided section to the color image difference derivation module 22, as shown in FIG. 6. Referring to FIG. 6, when the virtual content is divided by an interval A▴ in each of the vertical and vertical directions, the number of sections is S=(180*360)/A²). For example, in the case of A=10, a total of 648 sections may be generated.

The color image difference derivation module 22 derives a color image difference between the virtual content for each section and the original image in the corresponding section, which is matched to the section of the virtual content.

Here, the color image difference between the virtual content for each section and the original image that is matched to the section may be derived by performing first correction on an angular error between the original image and the virtual content using the scale invariant feature transform (SIFT) algorithm that matches feature points in the original image and the virtual content and then performing secondary correction on an angular error generated in the scale invariant feature transform (SIFT) calculation process. Here, the corresponding section refers to a section of the original image that is matched to the section of the virtual content.

Here, the color image refers to an RGB (Red, Green, Blue) image. The color image difference derivation module 22 generates and stores the union of the color image difference for each section. Accordingly, the color image differences for all sections may be expressed in the form of a matrix.

That is, a color image difference Drgb (r=a, s=b) of a section s=b of the virtual content created with a radius r=a may be expressed by Equation 1 below:

D_{rgb}(r=a,s=b)=|I_{rgb}(r=a,s=b)−M_{rgb}(r=a,s=b)| [Equation 1]

wherein I_{rgb}(r=a, s=b) is a color image of the original image, and M_{rgb}(r=a, s=b) is a color image of the virtual content.

In addition, the color image differences for all sections y=1˜S of the virtual content created with a radius r=a may be expressed as the union of the color image differences for all section, and the color image differences for all sections y=1 to S may be expressed by Equation 2 below:

$${{⋃}_{y = 1}}^{S} {D}_{rgb} ( r = a , s = y ) = {{⋃}_{y = 1}}^{S} [ \vert {I}_{rgb} ( r = a , s = y ) - {M}_{rgb} ( r = a , s = y ) \vert ] \qquad [ Equation 2 ]$$

In addition, the color image difference for all sections y=1 to S of the virtual content created with all radii belonging to r=A may be expressed as the union of the color image differences for all sections of the virtual content created with each reset radius r. The radii and color image differences for all sections y=1 to S may be expressed by Equation 3 below:

$${⋃}_{x ∈ A} {{⋃}_{y = 1}}^{S} {D}_{rgb} ( r = x , s = y ) = {⋃}_{x ∈ A} {{⋃}_{y = 1}}^{S} [ \vert {I}_{rgb} ( r = x , s = y ) - {M}_{rgb} ( r = x , s = y ) \vert ] \qquad [ Equation 3 ]$$

The union of color image differences for all sections for all the reset radii r may be delivered to a user terminal (not shown) in the form of a data stream. Accordingly, the user terminal allows for deriving the optimal radius from all radii using the union of the color image differences for all sections for all the reset radii r on the basis of the color image difference for each section, and creating high density content with the derived optimal radius for each section.

According to another embodiment, the optimal radius may be derived from all radii on the basis of the color image difference Drgb for each section, which is generated by the content creation server, whereby high density virtual content may be created with the derived optimal radius for each section.

In the following, processes of deriving the optimal radius from all radii on the basis of the color image difference Drgb for each section, which is generated by the content creation server and then creating high density virtual content with the derived optimal radius for each section will be described in more detail.

The optimal radius derivation module 23 sets a radius with the smallest size of the color image difference Drgb for each section as an optimal radius for each section. The smaller the color image difference Drgb means that the color image difference between the original image and the virtual content is smaller in the corresponding section. Accordingly, the virtual content created with the optimal radius with the smallest color image difference is determined to be high density.

Meanwhile, the virtual content performance evaluation unit 2 further includes a histogram generation module 24. Accordingly, the histogram generation module 24 generates a histogram for the color image differences Drgb for all sections y=1 to S for an arbitrary radius r=a, and evaluate the performance of the content for each section using the generated histogram.

The histogram generation module 24 derives each histogram for the color image difference of each radius, and the derived histogram for the color image difference of each radius is shown in FIG. 7. That is, referring to FIG. 6, the performance of virtual content created with a radius r=a may be quantitatively derived on the basis of 1 to 648 sections, a radius r=a, and a color image difference Drgb.

Meanwhile, the optimal radius for each section is delivered to the high density virtual content creation unit 3. The high density virtual content creation unit 3 performs Poisson disk sampling to remove points within the circle having the optimal radius and centered on the point of the point cloud for each section, thereby creating the virtual content for each section.

According to an example, the optimal radius is differently set for each section to perform Poisson disk sampling, and the samples are removed from the inside of the circle having the set optimal radius for each section and centered on the point of the extracted point cloud to create virtual content, thereby creating optimal high density virtual content.

Referring to FIG. 8, it may be noted that the optimal radius is differently set for each section to perform Poisson disk sampling, and the difference in a section-wise color image of the virtual content created with the optimal radius for each section is consistently small.

Although the embodiment of the present invention has been described above in detail, it will be understood by those skilled in the art using the basic concept of the present invention as defined in the following claims that the scope of the present invention is not limited thereto, but various modifications and improvements also fall within the scope of the present invention.

### INDUSTRIAL APPLICABILITY

According to the present invention, it is possible to implement a sense of reality for high density virtual content with a small number of samples and accordingly to create high density virtual content using a lightweight device, and further it is possible to quantitatively derive the performance of virtual content created with each reset radius using a histogram of the color image difference for each reset radius and accordingly to improve the reliability for the high density virtual content, since one point is selected within a point cloud extracted from the original image; the set radius is sequentially reset at predetermined interval using a ratio of the distance between the selected point and the closest point thereto to the resolution of the original image, to create virtual content for each reset radius; and a section-wise optimal radius is derived from all the radii on the basis of the color image differences between each created virtual content and the original image for each section, thereby creating virtual content with the derived optimal radius for each section. Therefore, the system and method for creation of high density virtual according to the present invention has industrial applicability, since it can improve accuracy and reliability of the operation and further the performance efficiency and can be applied in various fields; it may secure content technology in virtual spaces and thus make it possible to actively utilize monitoring in related industries; and it enables the marketing of AR/VR content and it makes it possible to be practically implemented in reality.

### DESCRIPTIONS OF REFERENCE NUMERALS

1: virtual content creation unit
11: radius setting module
12: virtual content creation module
13: radius resetting module
2: virtual content performance evaluation unit
21: section division module
22: color image difference derivation module
23: optimal radius setting module
24: histogram generating module
3: high density virtual content creation unit

1. A system for creation of high density virtual content, the system comprising:
a virtual content creation unit extracting a point cloud at an angle by scanning an object that is to be created as virtual content, removing samples in a circle having a radius and centered on a point in the extracted point cloud to create virtual content, and sequentially resetting the radius at predetermined intervals to create each virtual content for each of the reset radii;
a virtual content performance evaluation unit deriving a color image difference between the virtual content and an original image for each section and deriving an optimal radius for each section, from the radii reset based on the derived color image difference for each section; and
a high density virtual content creation unit creating high density virtual content for the optimal radius set for each section.

2. The system of claim 1, wherein the virtual content creation unit includes:
a radius setting module selecting the point in the point cloud extracted from the original image and setting the radius based on a ratio of a distance between the selected point and an adjacent point closest thereto to a resolution of the original image;
a virtual content creation module extracting the point cloud at the angle by scanning the object to be crated as virtual content in a virtual space, removing the sample in the circle having the radius and centered on the point in the extracted point cloud to create the virtual content; and
a radius resetting module sequentially resetting the radius at predetermined intervals, and
wherein the virtual content creation module is configured to create virtual content with for of radii sequentially reset.

3. The system of claim 2, wherein the virtual content performance evaluation unit includes:
a section division module dividing the virtual content created for each of the radii sequentially reset into a plurality of sections;
a color image difference derivation module comparing the original image with virtual content for each divided section to derive the color image difference for each section and thus generate a union of the color image difference for each section; and
an optimal radius setting module deriving the optimal radius for each section, from the radii reset based on the derived color image difference for each section.

4. The system of claim 3, wherein the union of the color image difference for each section is derived as the union of the difference between the original image Drgb(r=a, s=y) and the virtual content Drgb(r=a, s=y), in which the color image difference Drgb (r=a, s=y) for each section is provided to satisfy Equation 1 below:
$${{⋃}_{y = 1}}^{S} {D}_{rgb} ( r = a , s = y ) = {{⋃}_{y = 1}}^{S} [ \vert {I}_{rgb} ( r = a , s = y ) - {M}_{rgb} ( r = a , s = y ) \vert ] \qquad [ Equation 1 ]$$
wherein, r is a radius of Poisson disk sampling, s is a section number, and a and b are constants.

5. The system of claim 3, wherein the virtual content performance evaluation unit further includes a histogram derivation module that derives a histogram for the derived color image difference for each section, to quantitatively derive the performance for the virtual content with each radius reset based on the histogram for the color image difference for each section.

6. The system of claim 3, wherein the color image difference derivation module performs first correction on an angular error between the original image and the virtual content by using a scale invariant feature transform (SIFT) algorithm that matches each feature point of the original image with the virtual content, and then performs secondary correction on an angular error generated in the scale invariant feature transform (SIFT) calculation process, to compare the original image with virtual content for each section.

7. The system of claim 3, wherein the optimal radius is set as a radius with a smaller color image difference, from color image differences for each of the reset radii.

8. A method for creation of high density virtual content, the method comprising:
a virtual content creation step of extracting a point cloud at an angle by scanning an object that is to be created as virtual content, removing samples within a circle having a radius and centered on a point in the extracted point cloud to create virtual content, and sequentially resetting the radius at predetermined intervals to create each virtual content for each of the reset radii;
a virtual content performance evaluation step of dividing the created virtual content into sections, generating a color image difference between virtual content for each of divided sections and an original image thereto, and setting an optimal radius for each section based on the generated color image difference for each section; and
a high density virtual content creation step of creating high density virtual content for the optimal radius set for each section.

9. The method of claim 8, wherein the virtual content creation step includes:
a radius setting step of selecting the point in the point cloud extracted from the original image and setting the radius based on a ratio of a distance between the selected point and an adjacent point closest thereto to a resolution of the original image;
a virtual content creating step of extracting the point cloud at the angle by scanning the object to be crated as virtual content in a virtual space, removing the samples in the circle having the radius and centered on the point in the extracted point cloud to create the virtual content; and
a radius resetting step of sequentially resetting the radius at predetermined intervals, and
the virtual content creating step is performed after removing the samples in the circle having each of the reset radii.

10. The method of claim 8, wherein the virtual content performance evaluation step includes:
a section division step of dividing the virtual content created for each of the radii into a plurality of sections;
a color image difference derivation step of comparing the original image with virtual content for each divided section to derive the color image difference for each section and thus generate a union of the color image difference for each section; and
an optimal radius setting step of deriving the optimal radius for each section, from the radii reset based on the derived color image difference for each section.

11. The method of claim 10, wherein the color image difference derivation step includes performing first correction on an angular error between the original image and the virtual content by using a scale invariant feature transform (SIFT) algorithm that matches each feature point of the original image with the virtual content, and then performing secondary correction on an angular error generated in the scale invariant feature transform (SIFT) calculation process, to compare the original image with the virtual content for each divided section.

12. The method of claim 10, wherein the color image difference deriving step further includes a histogram derivation step of deriving a histogram for the derived color image difference for each section, to quantitatively derive the performance for the virtual content having each radius reset based on the histogram for the color image difference for each section.

13. A recording medium having a computer program to execute the method for creation of high density virtual content according to claim 8 recorded thereon, when executed on a computer.
